(19) United States
(12) Patent Application Publication
(10) Pub. No.: US 2019/0257381 A1
(43) Pub. Date: Aug. 22, 2019

(54) DAMPER ASSEMBLY FOR A VEHICLE

(71) Applicant: GM GLOBAL TECHNOLOGY OPERATIONS LLC, Detroit, MI (US)

(72) Inventors: Ravindra P. Patil, Troy, MI (US); Robert L. Geisler, Grand Blanc, MI (US)

(21) Appl. No.: 15/901,958

(22) Filed: Feb. 22, 2018

(51) Int. Cl. F16F 3/087; F16F 13/00; B60G 15/06

(52) U.S. Cl. CPC F16F 3/0873; F16F 13/007; B60G 15/065; F16F 2230/0023; F16F 2224/025; F16F 2224/0208; B60G 2800/162; F16F 2230/16; B60G 2202/312; B60G 2202/32; B60G 2206/42; B60G 2206/722; B60G 2206/73; F16F 2230/0005

(57) ABSTRACT

A damper assembly has a load management system comprising a jounce bumper, a striker cap conformably coupled to an end of the damper tube and a jounce bumper restraint attached to the striker cap and comprising an annulus that extends axially away from the striker cap and towards the jounce bumper, to define a jounce bumper rate cup therein. The striker cap and the annulus axially and radially engage the jounce bumper during impact events.

### INTRODUCTION

The subject disclosure generally relates to suspension systems for motor vehicles and, more particularly, to a damper assembly that reduces shock tower loading.

Motor vehicles include suspension systems that may include springs, dampers and support members extending between a vehicle body or frame and a set of road wheels. The suspension system expands and contracts in a controlled manner, in order to cushion relative movement between the body and wheels, as the vehicle traverses uneven terrain. When driving on relatively well developed roadways, the components of the suspension system dissipate the forces generated by bumps, potholes and other road anomalies in a controlled manner that helps a driver to maintain control of the vehicle and that provides a comfortable driving environment for the driver and passengers.

In severe service, when a vehicle suspension is exposed to high-impact events, excessive loading on the suspension components may cause compression beyond a set of limits or beyond the designed operating range of the components. Excessive relative movement between the body and the road wheels (“jounce”) may lead to potentially damaging collisions between suspension components and other vehicle elements. To prevent such collisions, suspension systems employ impact load management systems to limit excessive jounce. Such systems typically include jounce bumper assemblies that engage and compress during severe impact events to provide a bottoming or limit to further suspension travel. Jounce bumper assemblies may be conveniently located within the body of a suspension strut or damper assembly. The assemblies will typically include a rigid striker surface coupled to an end-cap of a strut damper tube and a polyurethane foam-based or rubber jounce bumper coupled to an upper strut assembly mount. The striker surface and the jounce bumper are aligned along a common piston rod axis and are spaced apart so that, during an impact event, the jounce bumper and the striker surface engage, causing the bumper to deform along the piston rod axis in the direction of loading.

The configuration of load management systems such as that described, may provide a minimum cushioning effect from impact loads because of the rigidity of the striker surface and the limited capacity of the foam bumper to absorb associated energy. Striker surfaces, jounce bumpers and associated mounting hardware can receive the brunt of impact loads leading to damage. As a result, these and other similarly affected elements, including the chassis frame and vehicle body structure are, necessarily, designed with a stronger construction and greater mass than might otherwise be required if the jounce bumper assembly were capable of absorbing higher levels of energy.

Accordingly, it is desirable to provide a jounce bumper assembly, for managing impact loads in a vehicle suspension system, which provides improved energy absorption and reduced peak strain to minimize damage to the assembly and allow for the use of lighter weight vehicle structures.

### SUMMARY

In an embodiment, a damper assembly comprises a first portion having an upper mounting bracket and an upper spring seat, a second portion having a lower mounting bracket, a damper tube and a lower spring and a coil spring circumferentially disposed about the first and second portions and aligned substantially co-parallel with the damper tube. A strut rod is rigidly coupled to the upper mounting bracket at a first end and is slideably coupled to the damper tube at a second end. A load management system comprises a jounce bumper secured to the upper mounting bracket, a striker cap coupled to an end of the damper tube and having an opening through which the strut rod passes, and a jounce bumper restraint attached to the striker cap and comprising an annulus that extends axially away from the striker cap and towards the jounce bumper, to define a jounce bumper rate cup therein. The striker cap and the annulus axially and radially engage the jounce bumper during impact events.

In addition to one or more of the features described herein, in another exemplary embodiment, the striker cap comprises a flexible material such as a thermoplastic or thermosetting elastomeric polymer.

In addition to one or more of the features described herein, in another exemplary embodiment, the striker cap comprises a steel plate.

In addition to one or more of the features described herein, in another exemplary embodiment, the jounce bumper comprises a flexible material such as a polyurethane foam or rubber.

In addition to one or more of the features described herein, in another exemplary embodiment, the annulus of the jounce bumper restraint constrains a radially outward expansion of the jounce bumper during impact events.

In addition to one or more of the features described herein, in another exemplary embodiment, the restraint imposed upon the jounce bumper by the annulus of the jounce bumper restraint is through the imposition of a hoop stress opposed to the direction of expansion.

In addition to one or more of the features described herein, in another exemplary embodiment, a vehicle comprises a chassis, a body supported by the chassis and comprising sprung vehicle mass and a suspension system and wheels comprising un-sprung vehicle mass. The suspension system provides a damped and stabilized coupling between the sprung and the un-sprung vehicle mass and comprises a first portion having an upper mounting bracket and an upper spring seat and a second portion having a lower mounting bracket, a damper tube and a lower spring. A coil spring is circumferentially disposed about the first and second portions and aligned substantially co-parallel with the damper tube. A strut rod is rigidly coupled to the upper mounting bracket at a first end and slideably coupled to the damper tube at a second end. A load management system comprises a jounce bumper secured to the upper mounting bracket, a striker cap conformably coupled to an end of the damper tube and having an opening through which the strut rod passes, and a jounce bumper restraint attached to the striker cap and comprising an annulus that extends axially away from the striker cap and towards the jounce bumper, to define a jounce bumper rate cup therein. The striker cap and the annulus axially and radially engage the jounce bumper during impact events.

The above feature and advantages, and other features and advantages of the embodiments are readily apparent from the following detailed description when taken in connection with the accompanying drawings.

### BRIEF DESCRIPTION OF THE DRAWINGS

Other features, advantages and details appear, by way of example only in the following detailed description of embodiments, the detailed description referring to the drawings in which:

FIG. 1 is a schematic view of a vehicle having a suspension system embodying features of the present disclosure;

FIG. 2 illustrates a suspension strut assembly, for use with the vehicle of FIG. 1, embodying features of the present disclosure;

FIG. 3 is a sectional view of the suspension strut assembly of FIG. 2, taken along axis A;

FIG. 4 is an enlarged portion of the upper strut assembly of FIG. 3;

FIG. 5 is an enlarged portion of the upper strut assembly of FIG. 3 shown under early conditions of extreme jounce;

FIG. 6 is an enlarged portion of the upper strut assembly of FIG. 3 shown under conditions of extreme jounce; and

FIG. 7 is a graph illustrating energy absorption of a strut assembly with and without features of the present disclosure.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

Various embodiments described herein provide an impact load management system having a jounce bumper assembly for managing the impact load, (“jounce”) in a vehicular suspension. The jounce bumper assembly is suitable for limiting jounce between suspension members such as, for example, a vehicle body or frame and a set of road wheels (i.e. sprung and un-sprung vehicle masses). When integrated within a suspension strut assembly, the jounce bumper assembly includes a striker cap in axial alignment with a jounce bumper. The striker cap is configured to be coupled to, and to overlap, the upper end of a cylindrical mount, such as a damper tube or striker cap support, and includes features that both axially and radially restrain the jounce bumper upon compression under impact loading. During impact events, one or both of the striker cap and the jounce bumper may deformably engage thereby absorbing energy that is generated by the impact load.

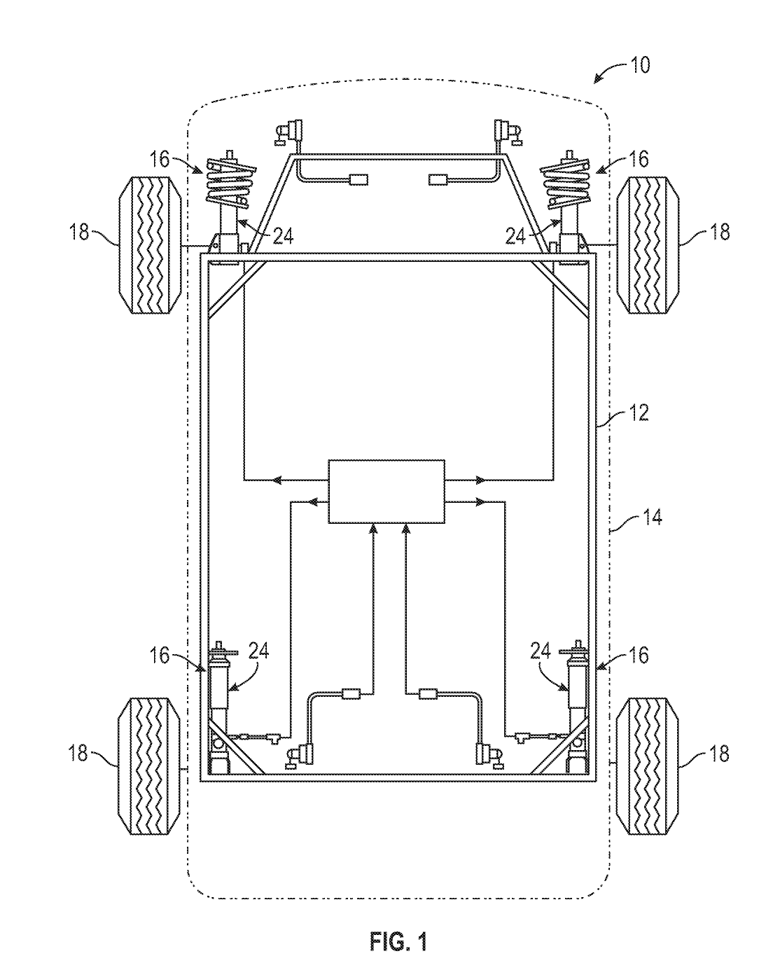

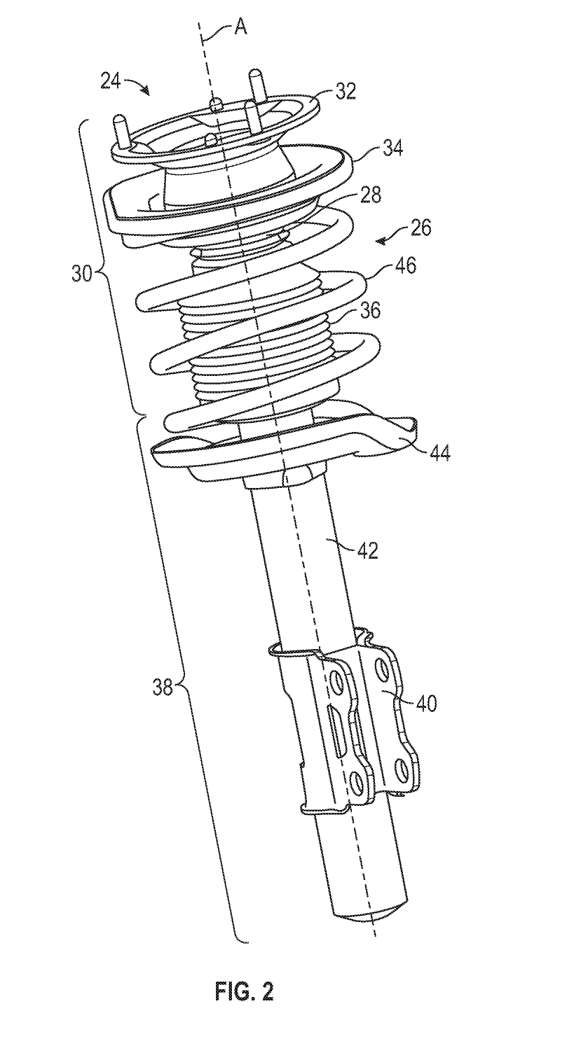

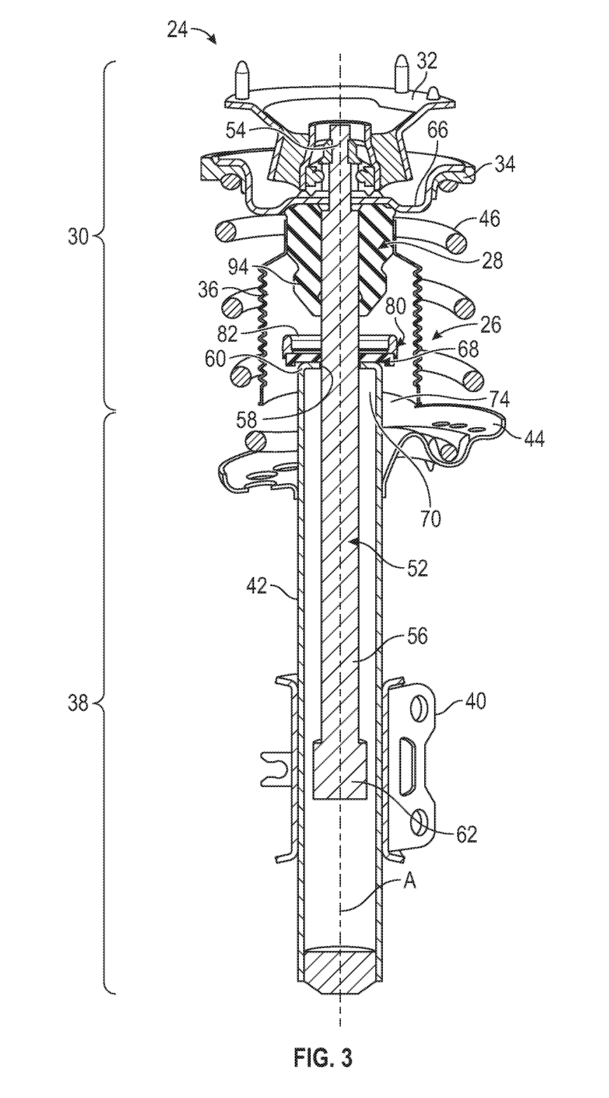

Referring to FIG. 1, a vehicle 10 (e.g. an automobile, truck, farm equipment, etc.) includes a chassis 12, a body 14 supported by the chassis, a suspension system 16 and wheels 18. The body 14 and chassis 12 may jointly define a vehicle structure and, may be referred to as “sprung” weight or mass. The wheels 18 are each rotationally coupled to the chassis 12 through the suspension system 16. The wheels 18 and the suspension system 16 may be referred to as “un-sprung” vehicle weight or mass. The suspension system 16 provides a damped and stabilized coupling between the sprung and the un-sprung vehicle mass and may include springs, linear actuators, control arms or links, and other interconnecting and supporting members to be described herein. The suspension system further includes at least one damper assembly 24 such as a shock absorber or a strut insert, or the like, for providing damping of motion between the sprung and the un-sprung vehicle masses. The suspension system 16 also includes a load management system 26, FIGS. 2 and 3 that includes an integrated jounce bumper 28. The load management system 26 absorbs energy in a space efficient manner during suspension impact events caused by excessive imperfections (ex. potholes) on the driven surface.

FIG. 2 illustrates a damper assembly 24 that is suitable for housing a load management system 26 including a jounce bumper 28 in accordance with an exemplary embodiment. The damper assembly 24 is attached between any two suitable components of the suspension system 16, FIG. 1, to dampen relative motion therebetween. Damper assembly 24 includes a first portion 30 that includes an upper mounting bracket 32, an upper spring seat 34 and an optional dust boot 36. In addition, a second portion 38 includes a lower mounting bracket 40, a damper tube 42 and a lower spring seat 44. The first and second portions 30, 38 respectively, are each substantially rigidly attached to suitable suspension system members (not shown) such as sprung and un-sprung vehicle masses using the upper and lower mounting brackets 32, 40 respectively. Damper assembly 24 also includes a coil spring 46 that, in an embodiment, may be circumferentially disposed about the first and second portions 30, 38 respectively, and aligned substantially co-parallel with damper tube 42. The coil spring 46 is bounded between, and retained in place by, upper spring seat 34 and lower spring seat 44. When the vehicle 10 is in motion, the first and second portions 30, 38 respectively, expand and contract relative to one another along an axis “A” of the damper assembly 24. Coil spring 46 provides resilient forces that tend to restore an equilibrium/relative height between sprung and un-sprung masses while damper 42 damps relative movement.

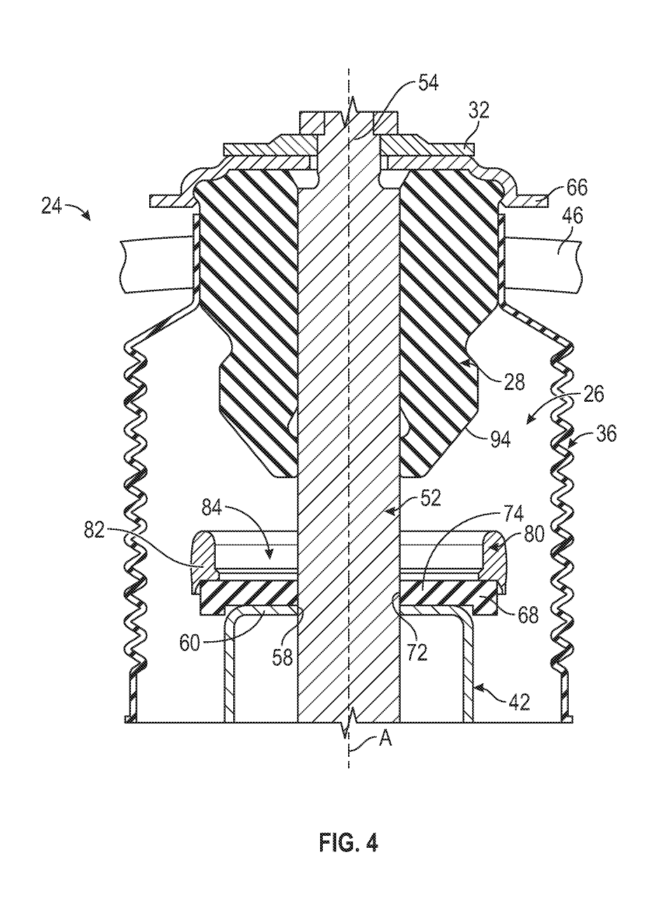

Referring to FIGS. 3 and 4, with continued reference to FIGS. 1 and 2, the damper assembly 24 includes an axially oriented (parallel to axis “A”) strut rod or piston rod 52 that is rigidly coupled to upper mounting bracket 32 at a first end 54 and slideably coupled to damper tube 42 at a second end 56. The strut rod 52 passes through an opening 58 in a substantially closed end 60 of the damper tube 42 for connection to a piston 62, located internally thereof in a known manner.

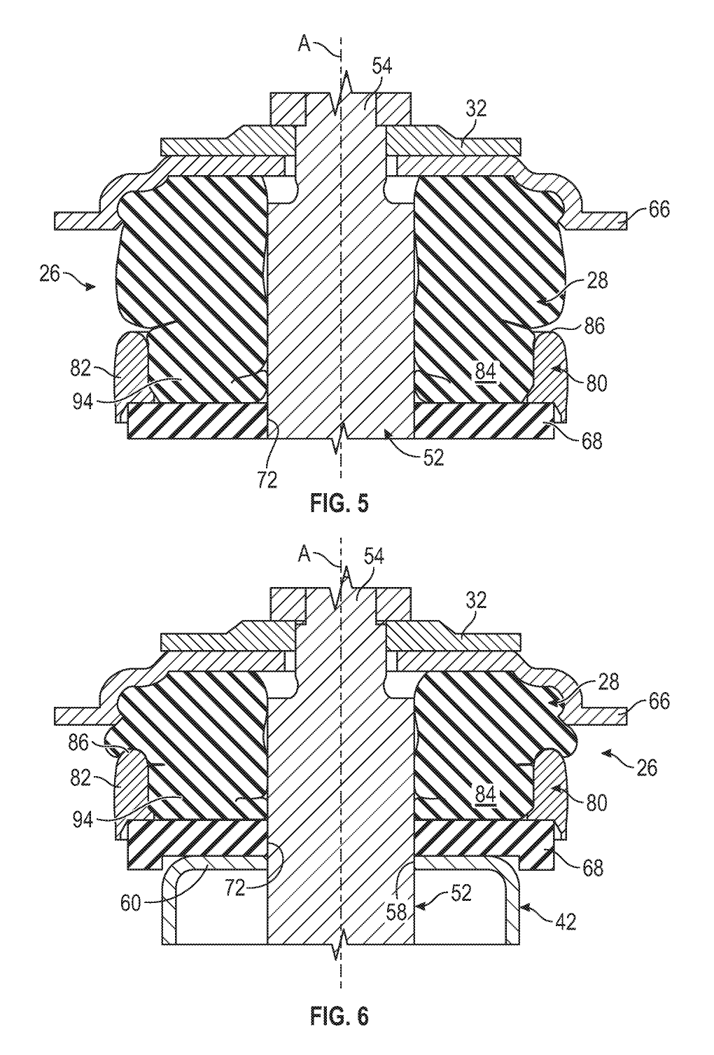

The damper assembly 24 includes load management system 26 that absorbs energy and limits excess compression (“jounce”) of the suspension system 16 during impact events. The load management system 26 may include jounce bumper 28, an upper mount 66 that secures the jounce bumper to the upper mounting bracket 32 and a striker cap 68. Jounce bumper 28 may comprise any suitable flexible material such as, for example, polyurethane foam or rubber. Jounce bumper 28 is attached to upper mount 66 and is circumscribed about, and moves axially with, strut rod or piston rod 52. Striker cap 68 may comprise any suitable material such as, for example, a thermoplastic or thermosetting elastomeric polymer. In another embodiment, the striker cap 68 comprises a steel plate. Striker cap 68 is conformably coupled to the closed end 60 of the damper tube 42, moves axially in unison therewith, and has an opening 72 that is axially aligned with opening 58 in closed end 60 of the damper tube 42 to thereby circumscribe the strut rod 52. Attached to the striker cap 68 is jounce bumper restraint 80 comprising an annulus 82 that extends axially away from the striker cap 68 and towards the jounce bumper 28 to thereby define a jounce bumper rate cup 84. The jounce bumper restraint 80 may be attached to the striker cap 68 through a press-fit or other suitable method of attachment. During extreme jounce events striker cap 68 and annulus 82 are configured to engage jounce bumper 28. In an example, during operation, and with reference to FIGS. 4, 5 and 6 the piston rod 52 oscillates in and out of the damper tube 42, in a well-known manner, to dampen relative motion between body 14 and the wheels 18, FIG. 1. The coil spring 46 also compresses and expands resiliently in concert with the described oscillations. During normal driving conditions that do not produce excessive jounce, end 94 of jounce bumper 28 and the striker cap 68 remain separated by a distance that varies in accordance with the relative motion between the piston rod 52 and the damper tube 42. During an impact event characterized by excessive jounce, however, the end 94 of the jounce bumper 28 and the striker cap 68 will contact and deformably engage to thereby absorb at least a portion of the energy generated by the impact, FIGS. 5 & 6. Deformation of the jounce bumper 28 is, initially at least, primarily in the axial direction as second end 94 contacts the striker cap 68, FIG. 5. As compression of the jounce bumper continues under increased compressive force, the jounce bumper 28 may expand in a direction that is radially oriented to the axis “A” until the bumper fills the jounce bumper rate cup 84 and contacts, and is constrained by, the annulus 82 of jounce bumper restraint. Radially outward expansion of the compressing jounce bumper 28 is constrained due to radial and hoop stresses imparted by the annulus 82.

For severe impact events, wherein maximum deflection of the jounce bumper 28 is reached, FIG. 6, further radial motion is prevented by the annulus 82 and the rigidity of the upper mount 66 thereby limiting the amount of elastic strain experienced by the jounce bumper 28 and preventing damage thereto. At this level of compression, the compressed jounce bumper 28 may roll over an upper lip 86 of annulus 82 with the result that additional energy is absorbed due to bending, under compression, of the cup wall 80.

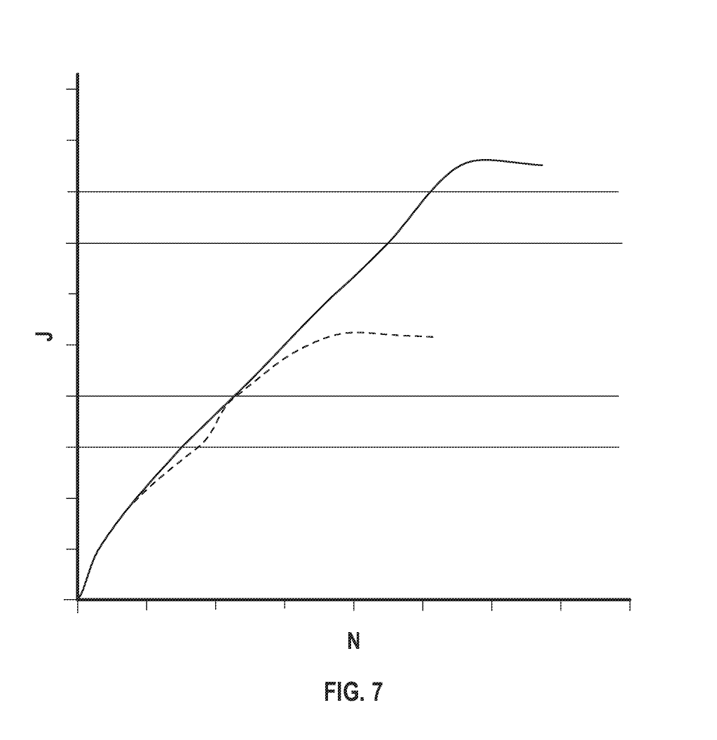

Referring to FIG. 7, the annulus 82 of the jounce bumper restraint 80 increases the energy absorption capabilities of the load management system 26. Under extreme load forces (“N”), the energy absorbed is higher thereby resulting in lower loading transmitted to vehicle components while also limiting strain damage to the jounce bumper 28.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A damper assembly comprising:
a first portion having an upper mounting bracket and an upper spring seat;
a second portion having a lower mounting bracket, a damper tube and a lower spring;
a coil spring circumferentially disposed about the first and second portions and aligned substantially co-parallel with the damper tube;
a strut rod rigidly coupled to the upper mounting bracket at a first end and slideably coupled to the damper tube at a second end; and
a load management system comprising;
a jounce bumper secured to the upper mounting bracket;
a striker cap conformably coupled to an end of the damper tube and having an opening through which the strut rod passes; and
a jounce bumper restraint attached to the striker cap and comprising an annulus that extends axially away from the striker cap and towards the jounce bumper, to define a jounce bumper rate cup therein, wherein the striker cap and the annulus axially and radially engage the jounce bumper during impact events.

2. The damper assembly of claim 1, wherein the striker cap comprises a flexible material such as a thermoplastic or thermosetting elastomeric polymer.

3. The damper assembly of claim 1, wherein the striker cap comprises a steel plate.

4. The damper assembly of claim 1, wherein the jounce bumper comprises a flexible material such as a polyurethane foam or rubber.

5. The damper assembly of claim 1, wherein the annulus of the jounce bumper restraint constrains a radially outward expansion of the jounce bumper during impact events.

6. The damper assembly of claim 5, wherein the restraint imposed upon the jounce bumper by the annulus of the jounce bumper restraint is through the imposition of a hoop stress opposed to the direction of expansion.

7. A vehicle comprising:
a chassis;
a body supported by the chassis and comprising sprung vehicle mass; and
a suspension system and wheels comprising un-sprung vehicle mass, wherein the suspension system provides a damped and stabilized coupling between the sprung and the un-sprung vehicle mass, the suspension system comprising:
a first portion having an upper mounting bracket and an upper spring seat;
a second portion having a lower mounting bracket, a damper tube and a lower spring;
a coil spring circumferentially disposed about the first and second portions and aligned substantially co-parallel with the damper tube;
a strut rod rigidly coupled to the upper mounting bracket at a first end and slideably coupled to the damper tube at a second end; and
a load management system comprising:
a jounce bumper secured to the upper mounting bracket;
a striker cap conformably coupled to an end of the damper tube and having an opening through which the strut rod passes; and
a jounce bumper restraint attached to the striker cap and comprising an annulus that extends axially away from the striker cap and towards the jounce bumper, to define a jounce bumper rate cup therein, wherein the striker cap and the annulus axially and radially engage the jounce bumper during impact events.

8. The vehicle of claim 7, wherein the striker cap comprises a flexible material such as a thermoplastic or thermosetting elastomeric polymer.

9. The vehicle of claim 8, wherein the striker cap comprises a thermoplastic polyurethane (TPU) foam.

10. The vehicle of claim 7, wherein the jounce bumper comprises a flexible material such as a polyurethane foam or rubber.

11. The vehicle of claim 7, wherein the annulus of the jounce bumper restraint constrains a radially outward expansion of the jounce bumper during impact events.

12. The vehicle of claim 11, wherein the restraint imposed upon the jounce bumper by the annulus of the jounce bumper restraint is through the imposition of a hoop stress opposed to the direction of expansion.

13. A damper assembly having a load management system comprising:
a jounce bumper;
a striker cap conformably coupled to an end of the damper tube and having an opening through which the strut rod passes; and
a jounce bumper restraint attached to the striker cap and comprising an annulus that extends axially away from the striker cap and towards the jounce bumper, to define a jounce bumper rate cup therein, wherein the striker cap and the annulus axially and radially engage the jounce bumper during impact events.
